(19) United States
(12) Patent Application Publication
(10) Pub. No.: US 2022/0380694 A1
(43) Pub. Date: Dec. 1, 2022

(54) Cannabis Waste Cooking Fuel and Animal Feed Pellets

(71) Applicant: Lance Patrick McDermott, Seattle, WA (US)

(72) Inventor: Lance Patrick McDermott, Seattle, WA (US)

(21) Appl. No.: 17/332,702

(22) Filed: May 27, 2021

(51) Int. Cl. C10L 5/44; C10L 5/36; A23K 10/37; A23K 40/10

(52) U.S. Cl. CPC C10L 5/445; C10L 5/363; A23K 10/37; A23K 40/10; C10L 2200/0469; C10L 2270/08

(57) ABSTRACT

Generally, this process relates to use of cannabis/Marijuana plant waste that would otherwise be disposed of by methods that create methane.

Presently most States require Producers to mix their cannabis plant waste with a biomass creating a nonhazardous solid waste that must be disposed of at landfills or composting facilities. However, most States also allow Beneficial Use Permits (WAC 173-350-200) to divert the nonhazardous waste to a process that has an environmentally positive affect.

I believe that my new method is the best suited to fulfill that environmental need and transform the cannabis waste compositions into a commercially useful product.

For cooking fuel sustainable harvest or wood industry waste hardwood is the preferred base material to mix with the cannabis plant waste. However, any other variety of suitable biomass or organic materials may also be used if readily available.

Heterocyclic amines (HCAs) are formed when meat is charred at a high temperature and polycyclic aromatic hydrocarbons (PAHs) are created from meat fats dripping onto an open fire. Smoking at low temperatures over a long period of time means that HCAs are not a problem since charring does not occur. Also smoking food is a healthier option because PAHs are barely a worry, and the same chemicals add a pleasant smell to the food when cooked.

Furthermore, different embodiments of my process can impart different types of smoked flavors depending on the base biomass mixed with the cannabis plant waste. Thus, carbon neutral when burned, fuel pellets can provide a wide range of smoked flavors to food to satisfy a variety of personal taste preferences.

For animal feed cannabis plant waste can be processed with other agro-industrial by-products such as sugar cane husks. Mixed with biomass proteins, minerals, and nutrients (vitamins) to create healthy animal feed.

The pellet mill process uses pressure to generate heat to make the feedstuffs into a more digestible form by breaking down the starches. The process puts the feed in a concentrated form and minimizes waste during the eating.

Compared with unprocessed grains, animal feed pellets are uniform and easily digested especially for foals, weanlings, and older animals.

Sending the solid waste to landfill and composting facilities creates methane from anaerobic fermentation. My process prevents anaerobic fermentation.

The reduction of one ton of methane is equivalent to 25 tons of carbon dioxide. Therefore, for every ton of methane reduced, 25 commercial valuable Carbon Credits can be issued.

The Producers as a result could receive tradable Carbon-Credits for the methane not created.

Flowchart Description
1. Pursuant to most State's regulations the cannabis producer will Mix 49% cannabis plant waste with 51% biomass material rendering it unfit for human consumption.
2. The nonhazardous waste will be Transport to the transformation facility.
3. At the transformation facility the waste will be Cleaned and Ground to suitable size.
4. The waste will be Mixed with additional ingredients and Dried.
5. The fuel or feed mixture will be Processed into pellets, pucks, briquettes, or other suitable forms needed.
6. The final product will be Package and sold as cooking fuel or animal feed.

While my above description contains basic specificities, these should not be construed as limitations on the scope, but rather as an exemplification of several embodiments thereof. Many other variations of cooking fuel or animal feed are possible. Other diverted solid waste such as nutshells used for cooking fuel or corn stock husk waste for animal feed.

A process for transforming cannabis/marijuana plant waste into a composition such as pellets that can be used as cooking fuel or animal feed.

### TECHNICAL FIELD

### Class Definition:

44/589 and/605, Vegetation material which would be thrown away if it were not salvaged.

44/590, Wood, sawdust or paper waste.

### CPC Class:

C10L 5/00-Solid fuels which is wood and cannabis waste usable as a cooking fuel:
C10L 5/06-Methods of forming the solid fuel briquettes or pellets.
C10L 5/363-Pellets as produced by pelletizer.
C10L 5/442-Solid fuel based on wood and cannabis waste.
C10L 5/445-Agricultural waste solid fuel pellets.

A23K 10/00-Animal feeding-stuffs:
A23K 10/37-From waste material.

My process utilizes cannabis plant waste mixed with a biomass to create a nonhazardous solid waste that is transformed in a process such as pelletization into a cooking fuel or animal feed.

Prior Art-Patents:

| U.S. Pat. No. | Kind Code | Issue Date | Patentee |
|---|---|---|---|
| 8,328,884 | B1 | Dec. 11, 2012 | Traeger Pellet Grills, LLC |
| 9,974,820 | B1 | May 22, 2018 | Ablett, Richard |
| 4,102,653 | B1 | Jul. 25, 1978 | Simmons, Charles |
| 4,960,438 | B1 | Oct. 2, 1990 | The Barkesh Company |

Prior Art-Applications:

| Application Number | Date Applied | Patentee |
|---|---|---|
| 20170202895 | Jul. 20, 2017 | Hugh, Kevin Anthony |
| 20200000863 | Jan. 2, 2020 | Millikin, Rory Chesley Patrick |

### Nonpatent Literature References

Colorado State University, 8 Mar. 2021, -“The life cycle greenhouse gas emissions from indoor cannabis cultivation, modeled across the U.S.”

Spectrum News, 10 Jun. 2020, -“Cannabis Industry Generates 150M Tons of Waste Annually.”

Leafly News, 4 Nov. 2019, -“The cannabis industry generates tons of extra waste.”

The Washington Post, 14 Aug. 2018, -“Garbage for Washington State's booming pot industry clogs gutters, sewers and landfills.”

The Stranger, 26 Jul. 2017, -“Washington's Weed Industry Has a Million-Pound Waste Problem.”

### DISCUSSION OF PRIOR ART

Currently organic matter from cannabis production is mostly disposed of by landfill and composting methods that create methane. Methane is 25 times more hazardous than Carbon Dioxide.

None of the prior Patents or Applications have invented a use for Cannabis Producers' nonhazardous plant waste material that is now being sent to landfills and composting centers.

None of the Prior Art involves using the cannabis waste as a biomass to create cooking fuel or animal food that can be sold commercially.

### Advantages Over Prior Art

My process would have the environmental benefit of removing cannabis plant waste from our nations' methane creating landfills and composting centers. (Washington State WAC 173-350-200 Beneficial Use Permit.)

### SUMMARY

As noted by the Literature References my process would cure a nation-wide cannabis Producers' waste problem. With the benefit to the Nation of removing millions of pounds of organic waste from landfills and composting. While contributing to a carbon neutral fuel source for healthy cooking of food and a process for healthy animal feed. Method as detailed in submitted Drawing.

1. The main object of this new process is to provide a commercial use for the cannabis/marijuana plant waste that is now going to methane creating landfills and composting centers.
A commercially viable product is made in the form of cannabis plant waste compressed with a suitable biomass to make carbon neutral cooking fuel. Cooking food with such pellets would exhibit unique flavor of the pellet.
Another commercially viable product is created from cannabis plant waste mixed with such suitable animal feed and formed into pellets. Providing a healthy animal food product.
An offshoot commercial product is the Carbon Credits issued to the Cannabis Producers who use this new transformation process for their cannabis plant solid waste.
The method for making cannabis waste pellets includes the steps of milling the combined mixture forming various products for cooking fuel or animal feed products.
The present process is intended to embrace all such alternatives, modifications and variances that fall within the scope of processing cannabis/marijuana plant waste material into cooking fuel or animal feed product.
